(19) United States
(12) Patent Application Publication
(10) Pub. No.: US 2016/0212158 A1
(43) Pub. Date: Jul. 21, 2016

(54) DISTRIBUTED PATTERN DISCOVERY

(71) Applicant: HEWLETT PACKARD ENTERPRISE DEVELOPMENT LP, Houston, TX (US)

(72) Inventors: FEI GAO, Santa Clara, CA (US); Zhipeng Zhao, Sunnyvale, CA (US); Anurag Singla, Sunnyvale, CA (US)

(21) Appl. No.: 14/914,088

(22) PCT Filed: Aug. 28, 2013
(86) PCT No.: PCT/US2013/056947

§ 371 Date: Feb. 24, 2016

(51) Int. Cl. H04L 29/06

(52) U.S. Cl. CPC H04L 63/1416; H04L 63/1425

(57) ABSTRACT

Example embodiments disclosed herein relate to distributed pattern discovery. Single item itemsets are received. A new candidate item set is built for the respective single item itemsets if the respective single item itemsets are a new single item set or an item set size of a respective transaction set of the respective single item itemset is below a threshold. The new candidate item set and a respective transaction identifier is outputted to a set of nodes.

### BACKGROUND

Security Information and Event Management (SIEM) technology provides real-time analysis of security alerts generated by network hardware and applications. SIEM technology can detect possible threats to a computing network. These possible threats can be determined from an analysis of security events.

### BRIEF DESCRIPTION OF THE DRAWINGS

The following detailed description references the drawings, wherein:

FIGS. 1 and 2 are block diagrams of a system capable of distributed pattern discovery, according to various examples;

FIG. 3 is a flowchart of a method for generating single item itemsets based on rules for distributed pattern discovery, according to one example;

FIG. 4 is a flowchart of a method for determining new candidate item sets for distributed pattern discovery, according to one example;

FIG. 5 is a flowchart of a method for outputting a tuple including a frequent item set, according to one example;

FIG. 6 is a flowchart of a method for determining discovered patterns from a tuple including a frequent item set, according to one example; and

FIG. 7 is a block diagram of a computing device capable of building new candidate item sets, according to one example.

### DETAILED DESCRIPTION

Pattern discovery is a data mining based preemptive approach to solve many challenges faced by a security information and event management (SIEM) system. With the proliferation of big security data and the advance collaborative techniques employed by professional information attackers, various challenges are being faced by SIEM systems such as zero day vulnerabilities explorations, slow attacks, long term penetration spreading from one system to another, and exfiltration of information. Further, hackers are adding new weapons, which have not been seen before, into their arsenals.

A preemptive approach can be used to detect system anomalies not by matching the known signatures, but by correlating security information and discovering the unknown patterns of traces in the system. Pattern Discovery in SIEMs is a powerful approach determining these vulnerabilities.

In certain examples, security information/event management for networks may include collecting data from networks and network devices that reflects network activity and/or operation of the devices and analyzing the data to enhance security. Examples of network devices may include firewalls, intrusion detection systems, servers, workstations, personal computers, etc. The data can be analyzed to detect patterns, which may be indicative of an attack or anomaly on the network or a network device. The detected patterns may be used, for example, to locate those patterns in the data. For example, the patterns may be indicative of activities of a worm or another type of computer virus trying to gain access to a computer in the network and install malicious software.

The data that is collected from networks and network devices is for events. An event may be any activity that can be monitored and analyzed. Data captured for an event is referred to as event data. The analysis of captured event data may be performed to determine if the event is associated with a threat or some other condition. Examples of activities associated with events may include logins, logouts, sending data over a network, sending emails, accessing applications, reading or writing data, port scanning, installing software, etc. Event data may be collected from messages, log file entries, which is generated by a network device, or from other sources. Security systems may also generate event data, such as correlation events and audit events.

In some examples, anomaly detection can also be achieved by building a baseline of the normal patterns of the system, which has been learned off line. When any anomaly occurs, the system can detect the new patterns and alert system management. Pattern discovery on a single node of a SIEM can be limited by the system resources (e.g. memory, IO bandwidth with a database (DB), etc.) so that it may lack the capacity to handle big data, which is common in a state-of-art enterprise security system. Further, if the pattern discovery is implemented in a batch mode, it is challenging to discover new patterns in real time.

Accordingly, various embodiments described herein relate to a real time distributed pattern discovery engine that can scale traditional pattern discovery. Further, various embodiments can be used to respond to new patterns in real time, when the data associated comes streaming in. The pattern discovery procedure can be streamed and divided into multiple stages. Further, multiple nodes can be used for the stages.

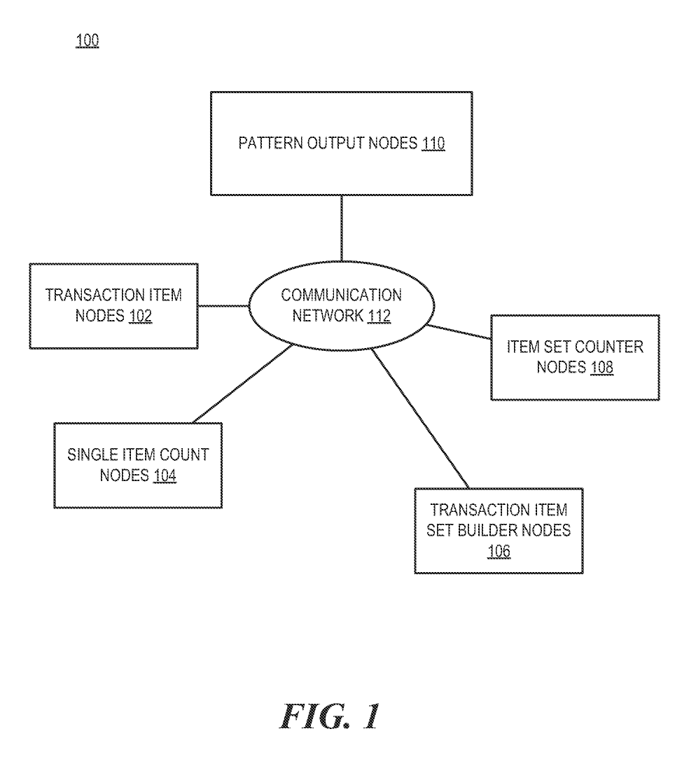

As further described in FIG. 1, these nodes can include transaction item nodes, single item count nodes, transaction item set builder nodes, item set counter nodes, and pattern output nodes. One or more nodes can be assigned at each stage of pattern discovery. In some examples a map/reduce, storm, or other methodology can be used to balance the workload. As such, the approaches described herein can avoid both data intensive I/O bottlenecks as well as computation intensive bottlenecks. Advantageously, the approaches described herein can improve performance in discovering real time patterns. The map/reduce and/or Storm methodologies can be implemented over a streaming processing framework to provide a mechanism to stream pattern discovery processing over multiple stages and parallelize the task in each stage over one or more nodes to avoid bottlenecks. This allows for security information and event data, which is continuously flowing to be processed in real time.

Nodes can examine event components and identify groups of correlated events as transactions. Frequent item sets can then be determined. In certain examples, frequent items sets are groups of correlated events that occur frequently together across different transactions. As such, one or more security events can be included in a transaction. Some of these frequent item sets, which can be customized, for example, to satisfy criteria specified by a consumer, are the trace for malicious attacks and could be used as signatures for further analysis.

This can be a case of associate item set mining, which can be formally stated as following: Let I={a₁, a₂, a₃, . . . , aₘ} be a set of items, and transaction database DB is a set of subset of I, denoted by DB={T₁, T₂, T₃, . . . , Tₙ}, where Tᵢ (1≦i≦n) is called a transaction. The support of a potential pattern A, denoted by supp(A), is the number of the transactions containing A in a DB and the length of the potential pattern A, denoted by length(A), is the number of the items in A. In one example, A is considered a frequent pattern if and only if supp(A)≧ξ₁ and length(A)≧ξ₂, where ξ₁ is a pre-defined threshold for pattern support and ξ₂ is a pre-defined threshold for pattern length. Examples of items can include fields and parameters for pattern discovery. A pattern length can be considered a number of activities.

According to an example, fields and parameters are selected for pattern discovery. Events in event data may have a multitude of attributes. The event data may be stored according to fields associated with the attributes of the events in the event data. A field, for example, is an attribute describing an event in the event data. Examples of fields include date/time of event, event name, event category, event ID, source address, source MAC address, destination address, destination MAC address, user ID, user privileges, device customer string, etc. The event data may be stored in a table comprised of the fields. In some cases, hundreds of fields reflecting different event attributes may be used to store the event data.

For pattern discovery, some of the fields are selected. For example, the selected fields may include a set of the fields from the table. The number of fields in the set may include one or more of the fields from the table. The fields selected for the set may be selected based on various statistics and may be stored in a pattern discovery profile. A pattern discovery profile is any data used to discover patterns in event data. The pattern discovery profile may include the set of fields, parameters and other information for pattern discovery.

In addition to including fields, parameters may be used for pattern discovery. The parameters may be included in pattern discovery profiles for pattern discovery. The parameters may specify conditions for the matching of the fields in the pattern discovery profile to event data to detect patterns. Also, the parameters may be used to adjust the number of patterns detected. One example of a parameter is pattern length that is a number of activities. The pattern length parameter may represent a minimum number of different activities that were performed for the activities to be considered a pattern. Another example of a parameter is a repeatability parameter that may represent a minimum number of times the different activities are repeated for them to be considered a pattern. In one example, repeatability is associated with two fields. For example, repeatability may be represented as different combinations of source and target fields across which the activity is repeated. A minimum number of different combinations of source and target IP addresses is an example of a repeatability parameter. These parameters may be adjusted until a predetermined amount of matching patterns is identified.

In certain examples, a pattern is a sequence of a plurality of different activities such as transactions. Frequent patterns can be detected as potential patterns that meet certain parameters, such as support and length. In an example of a pattern, the sequence of activities includes scan ports, identify open port, send packet with particular payload to the port, login to the computer system and store a program in a particular location on the computer system.

Also, patterns that are repeated are identified. For example, if a plurality of different activities is repeated, it may be considered a repetitive pattern. Also, a pattern may be between two computer systems. So the pattern can include a source field and a target field associated with the different computer systems. In one example, the source and target fields are Internet protocol (IP) addresses of the computer systems. The source and target fields describe the transaction between computer systems. Pattern activity may also be grouped together by other fields in addition or in lieu of one of the source and target fields. In one example, the pattern activity may be analyzed across User IDs to identify the sequence or collection of activity repeated by multiple users. In another example, the pattern activity may be analyzed across Credit Card Numbers or Customers to identify the sequence or collection of activity across multiple credit card accounts.

Other event fields, in addition or in lieu of one of the source and target fields may be included in a pattern discovery profile. In one example, a field is used to identify a specific pattern and is referred to as a pattern identification field. In one example, the pattern identification field is event name or event category. In another example, it can be the credit card transaction amount. In yet another example, it can be an Event Request URL field to detect application URL access patterns.

One simplistic example of a pattern for a virus is as follows. One event is a port scan. Scanning of the port happens on a source machine. The next event is sending a packet to the target machine. The next event can be a login to the target machine. The next event may be a port scan at the target machine and repetition of the other events. In this way, the virus can replicate. By detecting the repeated events as a pattern, the virus may be detected. For example, a selected field for pattern discovery may be event name and the repeatability parameter is 4 and the number of activities parameter is 3. The unique events that are detected have event names of port scan, packet transmission and login on target/destination machine. The number of events is 3. This pattern includes 3 different events (e.g., port scan, packet transmission and login on target/destination machine), which satisfies the number of activities parameter. If this pattern is detected at least a support number of times, for example during a pattern discovery run, then it satisfies the repeatability parameter, and it is considered a pattern match. A notification message or another type of alert may be generated.

Multiple pattern discovery profiles may be created to detect a variety of different parameters, if a pattern is detected, actions may be performed. For example if pattern represents an attack on network security, then notifications, alerts or other actions may be performed to stop the attack. Other actions may include displaying the events in the patterns for analysis by a network administrator.

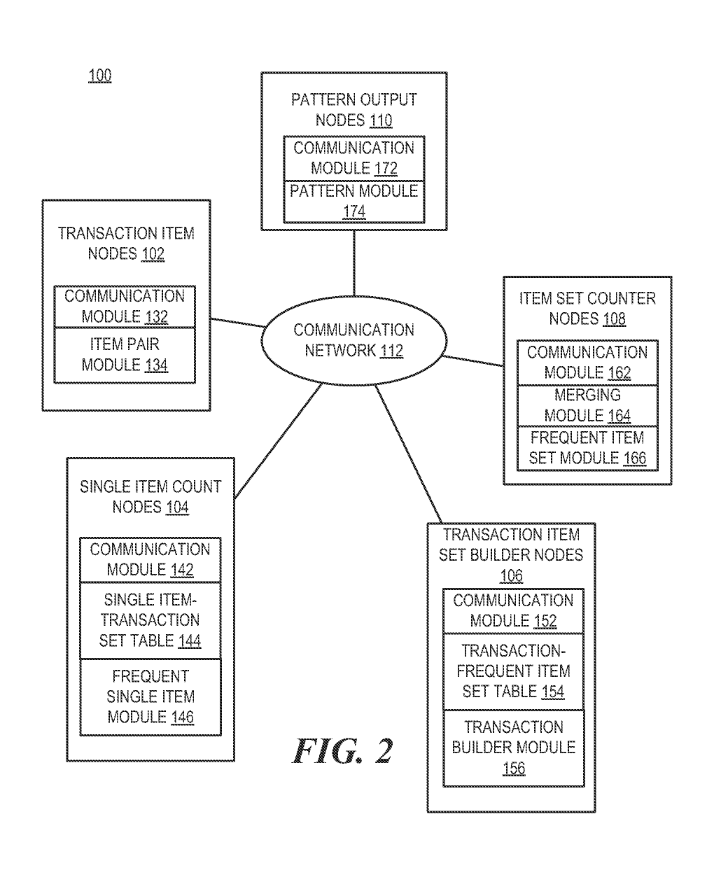

FIGS. 1 and 2 are block diagrams of a system capable of distributed pattern discovery, according to various examples. The system 100 can include Transaction Item Nodes 102, Single Item Count Nodes 104, Transaction Item Set Builder Nodes 106, Item Set Counter Nodes 108, Pattern Output Nodes 110 that communicate with each other and/or other devices via a communication network 112. In certain examples, the nodes 102, 104, 106, 108, 110 are computing devices, such as servers, client computers, desktop computers, mobile computers, etc. The nodes can be implemented via one or more processing elements, memory, and/or other components.

Each of the nodes can include a communication module 132, 142, 152, 162, 172. The communication modules 132, 142, 152, 162, 172 can be used to communicate between nodes and/or with other devices that are part of the communication network 112 and/or part of another network.

The approaches used herein can be used for distributed stream processing. In some examples, a distributed real time computing platform such as STORM or map/reduce methodologies can be used. Using distributed systems, big data can be processed by splitting data into independent smaller sections and process them in parallel. Scaling can also be facilitated using the approaches herein. The distributed computing platform can be used to process unbounded streams of data in real time.

The transaction item nodes 102 can include an item pair module 134. Nodes at this stage can receive transaction data from data collectors. The transaction data can be formatted based on where the data comes from. Data can come from various sources as noted above. Example sources include SIEM and Log Management devices but data can also be received directly from databases and file system. These transaction item nodes 102 can output item and transaction identifier (ID) pair to the next single item count nodes 104. As such, inputs to the single item count nodes 104 can be pre-processed and uniform. One example Output is included in Table 1:

TABLE 1

| Item | Transaction Identifier |
|---|---|
| Login | User1 |
| Source Control Access | User1 |
| Login | User2 |

The single item count nodes 104 can receive item and transaction ID pairs via the communication module 142. A single item-transaction set table 144 can be maintained. The single item-transaction set table 144 can include a count associated with the number of times a particular single item-transaction set.

TABLE 2
Single Item Transaction Set table:

| Item | TransactionSet |
|---|---|
| <Login> | <User1, User2, User3> |
| <Source Control Access> | <User1> |

TABLE 3
Output of Single Item Node:

| Itemset | TransactionSet |
|---|---|
| <Login> | <User1, User2, User3> |

If the size of a transaction set for an item is larger than a threshold, ξ₁, the single item is a frequent single item, and is made into a single item itemset. The single item itemset as well as its transaction set are together outputted to the transaction item set builder nodes 106. In some examples, in the scenario that the system would want to output the single frequent tern set, the single item itemset and transaction set can also be output to the pattern output nodes 110.

Moreover, in some examples, an additional split node can be included to split the transaction set of each itemset into individual transaction ID and output pairs of itemset with its transaction ID to the transaction item set builder nodes 106.

The transaction item set builder nodes 106 maintain a transaction-frequent item set table 154. Table 4 shows a brief example of a transaction-frequent item set table.

TABLE 4
Transaction-Frequent item set table:

| Transaction Identifier | Item |
|---|---|
| User1 | Login |
| User1 | Source Control Access |
| User2 | Login |

When a new pair of itemset with its transaction ID flows in, the transaction builder module 156 checks the table. If it is a new single item set or the item set size has not reached a threshold (e.g., max item size) of the transaction, the transaction builder module 156 will attempt to build all possible new candidate item sets with size=[incoming item set].size+1 and elements as incoming item set elements plus one of the frequent single item (not in the incoming item set) for transaction ID. The new candidate item sets, paired with its transaction ID, are output to the Item Set Counter Nodes 108. Example output is shown in Table 5:

TABLE 5

| Itemset | TransactionSet |
|---|---|
| <Login, Source Control Access> | <User1> |

The item set counter nodes 108 keep track of the transaction set for each candidate item sets. With new itemset—transaction IDs coming in, the merging module 164 unions the incoming transaction ID with the transaction set of the same itemset to generate a new tuple of itemset and Transaction Set (see example output below). After the merge, the frequent item set module 166 check if the new tuple makes the item set a frequent item set (e.g., if the corresponding transaction set size is larger than ξ₁). As such, the whether the new tuple is a frequent item set can be determined based on a set of rules. If so, the frequent item set is sent to the pattern output nodes 110. In some examples, the frequent item set is also sent to the additional split node, which can use it as a base to create the next level of candidate item sets. Example output is shown in Table 6:

TABLE 6

| Itemset | TransactionSet |
|---|---|
| <Login, Source Control Access> | <User1, User2, User3> |

The pattern output nodes 110 receive the frequent item sets. The pattern output nodes 110 outputs discovered patterns. For all incoming [item set]-[transaction set] pair, if the size of the item set is larger than ξ₂ and its corresponding transaction set size is larger than ξ₁, it is considered a discovered pattern that will be output. The pattern module 174 can generate pattern data associated with the discovered pattern to output. The output can be to one or more SEM, one or more other security devices (e.g., an intrusion prevention system), a database, etc. In some examples, the pattern data is formatted to the respective output type.

With the above approaches, the pattern discovery procedure can be separated into multiple stages/nodes and can discover patterns in real time. For each stage/set of nodes, a map/reduce methodology, STORM, or other processing can be used to balance workload among multiple nodes at the respective stage. Thus, the approaches described herein can avoid data and computation intensive bottlenecks while discovering patterns.

The communication network 112 can use wired communications, wireless communications, or combinations thereof. Further, the communication network 112 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 112 can be in the form of a direct network link between devices, Various communications structures and infrastructure can be utilized to implement the communication network(s).

By way of example, the nodes and/or other devices communicate with each other and other components with access to the communication network 112 via a communication protocol or multiple protocols. A protocol can be a set of rules that defines how nodes of the communication network 112 interact with other nodes. Further, communications between network nodes can be implemented by exchanging discrete packets of data or sending messages. Packets can include header information associated with a protocol (e.g., information on the location of the network node(s) to contact) as well as payload information. In some examples, the nodes can communicate via a separate network from other devices.

A processor, such as a central processing unit (CPU) or a microprocessor suitable for retrieval and execution of instructions and/or electronic circuits can be configured to perform the functionality of any of the modules 132, 134, 142, 144, 146, 152, 154, 156, 162, 164, 166, 172, 174 described herein. In certain scenarios, instructions and/or other information, such as pattern, event, and/or item information, can be included in memory. Input/output interfaces may additionally be provided by the nodes. For example, input devices, such as a keyboard, a sensor, a touch interface, a mouse, a microphone, etc. can be utilized to receive input from an environment surrounding a node. Further, an output device, such as a display, can be utilized to present information to users. Examples of output devices include speakers, display devices, amplifiers, etc. Moreover, in certain embodiments, some components can be utilized to implement functionality of other components described herein.

Each of the modules may include, for example, hardware devices including electronic circuitry for implementing the functionality described herein. In addition or as an alternative, each module may be implemented as a series of instructions encoded on a machine-readable storage medium of computing device and executable by at least one processor. It should be noted that, in some embodiments, some modules are implemented as hardware devices, while other modules are implemented as executable instructions.

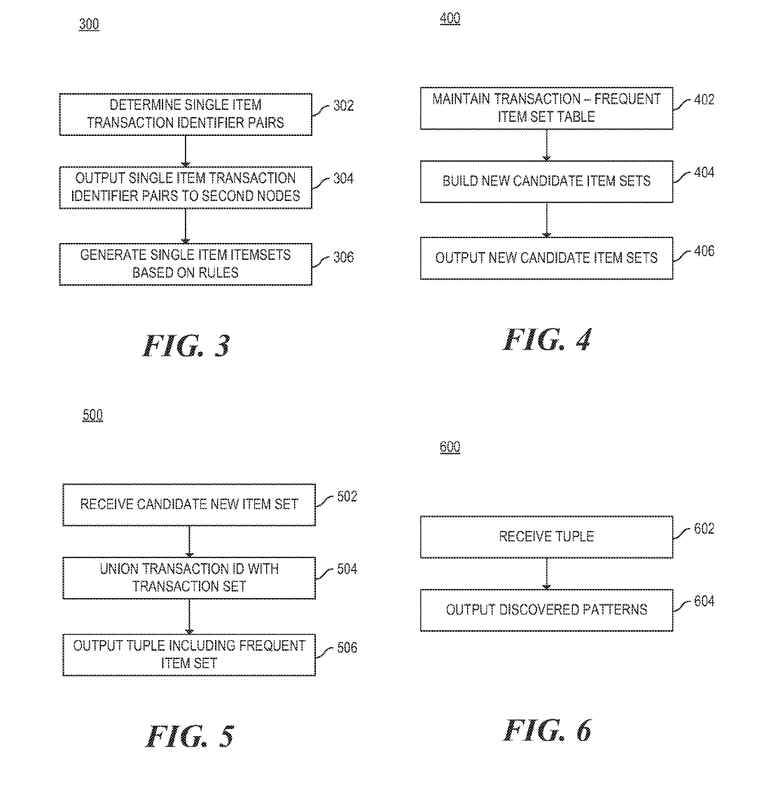

FIG. 3 is a flowchart of a method for generating single item itemsets based on rules for distributed pattern discovery, according to one example. One or more computing devices can be used to implement method 300. Additionally, the components for executing the method 300 may be spread among multiple devices. Method 300 may be implemented in the form of executable instructions stored on a machine-readable storage medium, and/or in the form of electronic circuitry.

Transaction item nodes 102 receive transaction data from collectors. The item pair modules 134 of the transaction item nodes 102 determine a plurality of single item and transaction identifier pairs from the transaction data as described above (302). At 304, the transaction item nodes 102 output the single item and transaction identifier pairs to a second set of nodes (e.g., single item count nodes 104).

The single item count nodes 104 receive the single item and transaction identifier pairs. The single item count nodes 104 determine if a transaction size of a transaction set of the single items is larger than a threshold. If so, the respective single item is marked as a respective frequent single item and a respective single item itemset is generated (306) as further detailed above. The respective single item itemset and the respective transaction set are sent to a third set of nodes (e.g., transaction item set builder nodes 106).

FIG. 4 is a flowchart of a method for determining new candidate item sets for distributed pattern discovery, according to one example. Nodes of system 100 may be used to implement the method 400. Additionally, the components for executing the method 400 may be spread among multiple devices. Method 400 may be implemented in the form of executable instructions stored on a machine-readable storage medium, and/or in the form of electronic circuitry.

The transaction item set builder nodes 106 can receive the single item itemsets from one or more single item count nodes 104. One of the nodes can receive a particular itemset based on load balancing. At 402, the transaction item set builder nodes 106 can maintain transaction-frequent item set tables. Each node can maintain its own table and/or a common resource (e.g., a database) can be used.

The transaction item set builder nodes 106 can determine whether respective single item itemsets are a new single item item set or has an item set size of corresponding transaction set below a threshold. If so, at 404, the transaction item set builder nodes 106 can build new candidate item sets as detailed above. At 406, the new candidate item set and respective transaction identifier are output (e.g., to item set counter nodes 108).

FIG. 5 is a flowchart of a method for outputting a tuple including a frequent item set, according to one example. Nodes of system 100 may be used to implement the method 500. Additionally, the components for executing the method 500 may be spread among multiple devices. Method 500 may be implemented in the form of executable instructions stored on a machine-readable storage medium, and/or in the form of electronic circuitry.

At 502, item set counter nodes 108 can receive new candidate item sets from method 400. The node that receives the new candidate item sets can be determined using STORM or a map/reduce load balancing solution. At 504, a merging module 164 merges the new candidate item set transaction identifier with a corresponding transaction set for the candidate item set to generate a new tuple as detailed previously. The Frequent item set module 166 checks the new tuple to determine whether the new tuple makes the candidate item set a frequent item set based on a set of rules. In one example, the rules can be that the item set is a frequent item set if the corresponding transaction set size is larger than At 506, if there is a frequent item set, the tuple and frequent item set is outputted, for example, to a set of pattern output nodes 110.

FIG. 6 is a flowchart of a method for determining discovered patterns from a tuple including a frequent item set, according to one example. Nodes of system 100 may be used to implement the method 600. Additionally, the components for executing the method 600 may be spread among multiple devices. Method 600 may be implemented in the form of executable instructions stored on a machine-readable storage medium, and/or in the form of electronic circuitry.

At 602, a set of pattern output nodes 110 receives a tuple and frequent item set outputted from method 500. An individual node can receive the tuple and frequent item set based on a load balancing system such as the STORM architecture or a map/reduce methodology.

In one example, for all incoming [item set]-[transaction set] pair, if the size of the item set is larger than ξ₂ and its corresponding transaction set size is larger than ξ₁, it is considered a discovered pattern that will be output. The pattern module 174 can generate pattern data associated with the discovered pattern to output. At 604, the discovered patterns are outputted. The output can be to one or more SEM, one or more other security devices (e.g., an intrusion prevention system), a database, etc. In some examples, the pattern data is formatted to the respective output type.

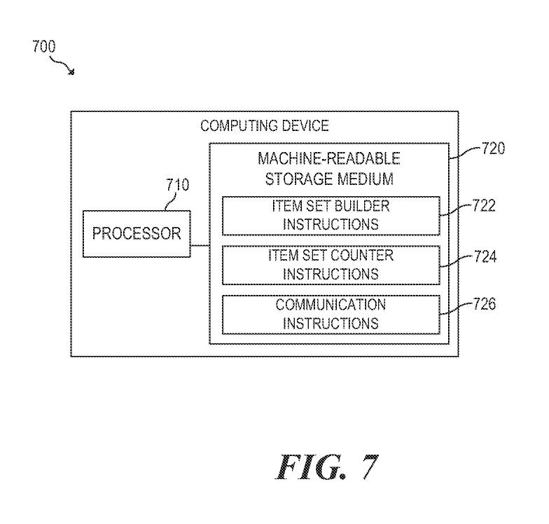

FIG. 7 is a block diagram of a computing device capable of building new candidate item sets, according to one example. The computing device 700 includes, for example, a processor 710, and a machine-readable storage medium 720 including instructions 722, 724, 726 for building new candidate item sets. Computing device 700 may be, for example, a notebook computer, a server, a workstation, a desktop computer, or other computing device.

Processor 710 may be, at least one central processing unit (CPU), at least one semiconductor-based microprocessor, at least one graphics processing unit (GPU), other hardware devices suitable for retrieval and execution of instructions stored in machine-readable storage medium 720, or combinations thereof. For example, the processor 710 may include multiple cores on a chip, include multiple cores across multiple chips, multiple cores across multiple devices (e.g., if the computing device 700 includes multiple node devices), or combinations thereof. Processor 710 may fetch, decode, and execute instructions 722, 724, 726 to implement methods, such as method 400. Similarly, other devices may be capable of reading instructions from other non-transitory machine-readable storage-media to perform methods such as method 300, 500, 600, etc. As an alternative or in addition to retrieving and executing instructions, processor 710 may include at least one integrated circuit (IC), other control logic, other electronic circuits, or combinations thereof that include a number of electronic components for performing the functionality of instructions 722, 724, 726.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 720 may be encoded with a series of executable instructions for building candidate item sets.

The computing device can execute communication instructions 726 to send and receive communications to/from other devices. In one embodiment, the computing device receives single item itemsets from one or more single item count nodes 104. The computing device 700 can represent one node of a set of transaction item set builder nodes. It can be decided that the respective single item itemsets are sent to/received by the computing device 700 based on a load balancing approach. In some examples, a map/reduce approach or STORM can be used. Further, the single item itemsets can correspond to respective items whose respective transaction set size is larger than a threshold (e.g., larger than ξ₁). These can be processed at one or more single item count nodes 104 that can receive item pairs from a set of transaction item nodes 102. As noted above, the transaction item nodes 102 can receive data to be analyzed from data collectors.

The computing device can maintain a transaction-frequent item set table. When a new pair of itemset with its transaction ID flows in, item set counter instructions 724 can be executed to check the table. If it is a new single item set or the item set size has not reached a threshold (e.g., max item size) of the transaction, the tern set builder instructions 722 can be executed to attempt to build all possible new candidate item sets with size=[incoming item set].size+1 and elements as incoming item set elements plus one of the frequent single item (not in the incoming item set) for transaction ID. As such, a new candidate item set is built for the respective single item itemsets if the respective single item itemsets are a new single item itemset or an item set size of a respective transaction set of the respective single item itemset is below a threshold. The new candidate item sets, paired with its transaction ID, are output. In some examples, the output is to a set of item set counter nodes as described above.

What is claimed is:

1. A system for distributed pattern discovery comprising:
a plurality of nodes each comprising at least one processor and memory,
wherein a first one of the nodes is a transaction itemset builder node that receives a plurality of itemset and transaction identifier pairs from a plurality of the other nodes;
wherein the first node determines if the itemset and transaction identifier pairs are new compared to a frequent item set table;
wherein the first node determines whether the respective itemset and transaction identifier pairs have a count that is below a threshold item set size for a transaction; and
if the respective itemset and transaction identifier pairs have the count that is below the threshold item set size, the first node generates a new candidate itemset paired with its respective transaction identifier and sends the new candidate itemset pair to a second one of the nodes.

2. The system of claim 1, further comprising;
the second one of the nodes that is an item set counter node that receives the new candidate itemset pair;
wherein the second node tracks a plurality of transaction sets for each of the new candidate itemset pairs and merges the respective transaction identifier with a transaction set of the same candidate item set to generate a new tuple.

3. The system of claim 2,
wherein the second node determines whether the new tuple is a frequent item set based on a set of rules; and
wherein, if the new tuple is a frequent item set, the new triple is sent to a third node of the nodes.

4. The system of claim 3, further comprising:
the third node that is a pattern output node, wherein the pattern output node receives the new tuple and generates pattern data associated with the new tuple.

5. The system of claim 1, further comprising:
a fourth one of the nodes that maintains a single item-transaction set table, wherein if a size of a transaction set for a single item and it's respective transaction identifier is larger than a threshold, the single item is marked as a frequent single item and one of the itemset and transaction identifier pairs is generated.

6. The system of claim 5, further comprising;
a fifth one of the nodes that receives transaction data from data collectors, generates the single item and respective transaction identifier, and outputs the single item and respective transaction identifier to the fourth node.

7. A method for distributed pattern discovery comprising:
receiving transaction data from collectors at a first set of nodes;
determining a plurality of single item and transaction identifier pairs from the transaction data;
outputting the single item and transaction identifier pairs to a second set of nodes,
wherein the second set of nodes determine if a transaction size of a transaction set for each of the single items is larger than a threshold and if so, the respective single item is marked as a respective frequent single item and a respective single item itemset is generated,
wherein the respective single item itemset and the respective transaction set are sent to a third set of nodes.

8. The method of claim 7, further comprising:
receiving the respective single item itemsets at the third set of nodes;
determining whether the respective single item itemsets is a new single tern set or an item set size of the respective transaction set is below a threshold, building a new candidate item set for the respective single item itemsets;
outputting the new candidate item set and respective transaction identifier to a fourth set of nodes.

9. The method of claim 8, further comprising:
receiving, at the fourth set of nodes, the new candidate item set;
merging the new candidate item set transaction identifier with a corresponding transaction set for the candidate item set to generate a new tuple.

10. The method of claim 9, further comprising:
checking the new tuple to determine whether the new tuple makes the candidate item set a frequent item set based on a set of rules.

11. The method of claim 10, further comprising:
outputting the new tuple to a fifth set of nodes, wherein the fifth set of nodes generates an associated pattern for the frequent item set.

12. A non-transitory machine-readable storage medium storing instructions that, if executed by at least one processor of a device for distributed pattern discovery, cause the device to:
receive single item itemsets;
build a new candidate item set for the respective single item itemsets if the respective single item itemsets are a new single item set or an item set size of a respective transaction set of the respective single item itemset is below a threshold, and
output the new candidate item set and respective transaction identifier to a set of nodes.

13. The non-transitory machine-readable storage medium of claim 12, wherein the respective single item itemsets are received from a plurality of nodes and correspond to respective items whose respective transaction set size is larger than a threshold.

14. The non-transitory machine-readable storage medium of claim 13, wherein the respective single tern itemsets are further based on data collectors processed at another plurality of nodes.

15. The non-transitory machine-readable storage medium of claim 13, wherein the device is selected to receive the respective single item itemsets based on load balancing.
